(19) United States
(12) Patent Application Publication
(10) Pub. No.: US 2012/0310408 A1
(43) Pub. Date: Dec. 6, 2012

(54) VENDING MACHINE ORDERING

(75) Inventors: Oliver Joerg STACHE, Niederkruechten (DE); Antonio Solano Tarroc, Madrid (ES); Andreas Nils Walter Cronstrom, Malmo (SE); Susana Margarida Cardim Cabaco, Carnaxide (PT); Tiago Andre Dias Do Naschiento Pergira Camilo, Quinta do Anjo (PT); Damian Czernous, Wroclaw (PL)

(73) Assignee: NOKIA SIEMENS NETWORKS OY, Espoo (FI)

(21) Appl. No.: 13/151,402

(22) Filed: Jun. 2, 2011

(51) Int. Cl. G06Q 30/00; G06F 7/00

(52) U.S. Cl. 700/237; 705/26.1; 705/27.1

(57) ABSTRACT

A method is described in which a user places an order for a vending machine product, typically when the user is not located at the vending machine. The order is associated with a mobile communication device of the user, for example by providing the telephone number of the device, or by simply placing the order using the mobile communication device. The user presents the mobile communication device at the vending machine to identify the order at the vending machine. The vending machine then dispenses the product.

The invention relates to vending machines. In particular, the invention relates to vending machines that are able to interact with other devices, such as mobile communication devices.

Vending machine technology is well established. Such machines typically dispense relatively low value items, such as snacks and drinks, in significant quantities.

Vending machines are not generally flexible. Products are available at fixed prices and, when sold out, need to be replaced. The period of such replacements can be unpredictable. Vending machines also do not typically allow users to order products remotely, nor do they typically allow either users or vending machine providers to check on the availability of stock at a particular vending machine without visiting the machine in person.

A further problem with vending machines is the lack of user-interaction. Many consumers require significant information regarding a product before they are willing to buy it. For example, some consumers have specific dietary requirements, for example due to allergies, dieting and/or fitness regimes, or ethical concerns (such as a desire to avoid meat products, or to purchase products manufactured in accordance with certain ethical principles).

It is technically possible to provide vending machines with substantial user-interaction. For example, video screens can be provided to present information to users and graphical user-interfaces can be provided to enable users to browse available information. However, providing such interaction is expensive. Since vending machines typically dispense inexpensive products with small profit margins, the cost of providing, maintaining and upgrading such interaction capability is prohibitive. Moreover, given the fragmented nature of the vending machine industry, individual vending machine providers are not typically able to make the financial commitment necessary to provide such services to end users.

The present invention seeks to address at least some of the problems outlined above.

The present invention provides a method (carried out by a user) comprising: placing an order for a vending machine product (the user could do this anywhere, using any device and does not (necessarily) need to be physically close to the VM); associating the order with a mobile communication device; and using the mobile communication device to identify the order at the vending machine in order to complete the order (the product(s) are then dispensed when order complete).

The step of placing the order for a vending machine product may be carried out using the said mobile communication device. This is not essential to all embodiments of the invention. For example, the user interaction step could be carried out using some other computing device, such as a laptop.

In some forms of the invention, using the mobile communication device to identify the order comprises presenting the mobile communication device to a near-field communication interface at the vending machine. However, many alternative identification mechanisms could be used, e.g. a Bluetooth connection between the mobile communication device and the vending machine. Using GSM or other cellular mobile communication systems is also possible.

Alternatively, or in addition, the step of identifying the order may include entering a personal identification number (PIN) at the vending machine. The PIN may be issued by the software module. The PIN may be sent to the mobile communication using a messaging system, such as an SMS. A similar effect could be achieved by sending other information to the mobile device, such as a barcode that needs to be presented to the vending machine. The steps could be in addition to, or instead of, identifying the mobile device using NFC/Bluetooth or other wireless methods.

Payment for the order may be made at a server remote from the vending machine (e.g. at the server where the order is placed, i.e. part of the “placing an order” step of the invention). This is not essential to all forms of the invention. For example, payment could be made at the vending machine.

The vending machine used to dispense the product may be selected under the control of the server. The user may be able to browse a number of available vending machines, for example using a user interface controlled by the server. Vending machine selection (or browser display) may be at least partially dependent on user history (i.e. which vending machines the user has used in the past). Vending machine selection (or browser display) may be at least partially dependent on the location of the user (i.e. suggesting local vending machines). Vending machine selection (or browser display) may be at least partially dependent on the product(s) of interest/ordered by the user.

The present invention also provides a mobile communication device comprising: a first interface configured to communicate with a server to place an order for a vending machine product (user could do this anywhere and does not (necessarily) need to be physically close to the vending machine); and a second interface configured to communicate with the vending machine to identify the order at the vending machine in order to complete the order (product(s) dispensed when order complete). A third interface configured to communicate with the server to associate the order with a mobile communication device may be provided.

The second interface may be a near-field communication interface; however, alternative identification mechanisms could be used, e.g. a Bluetooth connection between the mobile communication device and the vending machine. Using GSM communications is also possible. Other alternatives include, for example, providing a PIN or a visual marker, such as a barcode.

The present invention further provides a method (carried out at a vending machine) comprising: receiving data from a server regarding a product ordered by a user; receiving identification data from the server identifying a mobile communication device of the user; obtaining identification details of a presented mobile communication device; determining whether the identification details of the presented mobile communication device match the identification data received from the server; and if the presented mobile communication device matches the identification data received from the server, dispensing the ordered product.

The step of obtaining identification details of the presented mobile communication device may user a near-field communication link, although other options are possible as discussed elsewhere in this document.

The method may further comprises reserving the ordered product for the user.

The method may further comprising obtaining payment from the user. This is not essential to all forms of the invention, since payment may be obtained by the server (rather than by the vending machine).

In some forms of the invention, the server is informed that the product has been dispensed. Other information may be provided by the vending machine to the server, such as confirmation that a product is in stock or confirmation that a product has been reserved for the user. The server may maintain and update a database relating to the server on the basis of these communications.

The present invention yet further provides a vending machine comprising a first communication interface, a second communication interface and a product dispenser, wherein: the first communication interface is configured to communicate with a server for receiving order information identifying a product ordered by a user and identifying a mobile communication device of the user; the second communication interface is configured to receive identification details of a mobile communication device presented at the vending machine; and the product dispenser is configured to dispense the ordered product in the event that the mobile communication device presented at the vending machine matches the mobile communication device of the user.

The second communication interface may comprise a near-field communication link. Alternatively, or in addition, the second interface may comprise a personal identification number (PIN) entry mechanism.

In some forms of the invention, the dispenser reserves the ordered product for the user.

The vending machine may further comprise a processor for determining whether a mobile communication device presented at the vending machine matches the mobile communication device of the user.

A third interface may be provided for informing the server that the product has been dispensed.

The present invention also provides a method (carried out at a server) comprising: receiving an order for a vending machine product from a user; associating the order with a mobile communication device of the user; and sending order information to the vending machine, wherein the order information includes details of the product and details of the mobile communication device.

The method may further comprise receiving payment for the ordered product. Payment may be made at the server; alternatively, payment may be made at the vending machine.

The method may further comprise presenting information to the user regarding one or more available vending machines and/or one or more available products. Thus, the user is able to browse available vending machines and/or available products.

The server may maintain and update a database. To assist with this, the server may receive status information from vending machines supported by the server; for example, an “order complete” message may be sent to the server when a product is dispensed.

The present invention yet further provides a server comprising: a first input for receiving an order for a vending machine product from a user; a processor for associating the order with a mobile communication device of the user; and a first output for sending order information to the vending machine, wherein the order information includes details of the product and details of the mobile communication device.

The server may further comprise a payment module configured to obtain payment for the ordered product from the user.

The server may further comprise a second output for providing information to the user regarding one or more available vending machine and/or one or more available products. Thus, the user is able to browse available vending machines and/or available products.

The server may maintain and update a database. To assist with this, the server may receive status information from vending machines supported by the server; for example, an “order complete” message may be sent to the server when a product is dispensed.

The present invention further provides a computer program comprising: code (or some other means) for placing an order for a vending machine product; code (or some other means) for associating the order with a mobile communication device; and code (or some other means) for using the mobile communication device to identify the order at the vending machine in order to complete the order. The computer program may be a computer program product comprising a computer-readable medium bearing computer program code embodied therein for use with a computer.

The present invention yet further provides a computer program comprising: code (or some other means) for receiving data from a server regarding a product ordered by a user; code (or some other means) for receiving identification data from the server identifying a mobile communication device of the user; code (or some other means) for obtaining identification details of a presented mobile communication device; code (or some other means) for determining whether the identification details of the presented mobile communication device match the identification data received from the server; and if the presented mobile communication device matches the identification data received from the server, code (or some other means) for dispensing the ordered product. The computer program may be a computer program product comprising a computer-readable medium bearing computer program code embodied therein for use with a computer.

The present invention also provides a computer program comprising: code (or some other means) for receiving an order for a vending machine product from a user; code (or some other means) for associating the order with a mobile communication device of the user; and code (or some other means) for sending order information to the vending machine, wherein the order information includes details of the product and details of the mobile communication device. The computer program may be a computer program product comprising a computer-readable medium bearing computer program code embodied therein for use with a computer.

Exemplary embodiments of the invention are described below, by way of example only, with reference to the following numbered drawings.

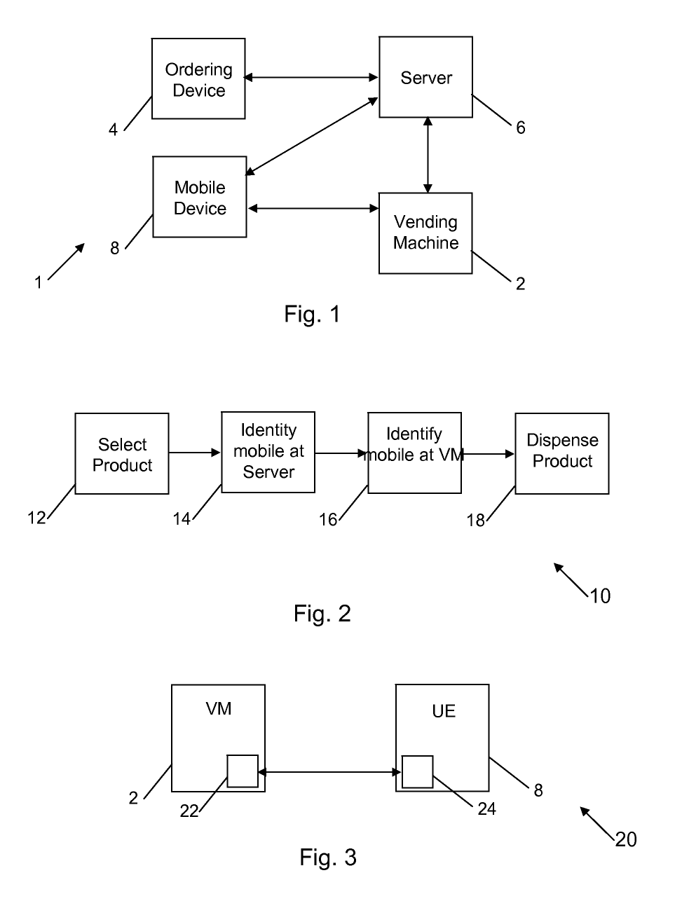

FIG. 1 is a block diagram of a system in accordance with an aspect of the present invention;

FIG. 2 is a flow chart showing an algorithm in accordance with an aspect of the present invention;

FIG. 3 is a block diagram of a system in accordance with an aspect of the present invention;

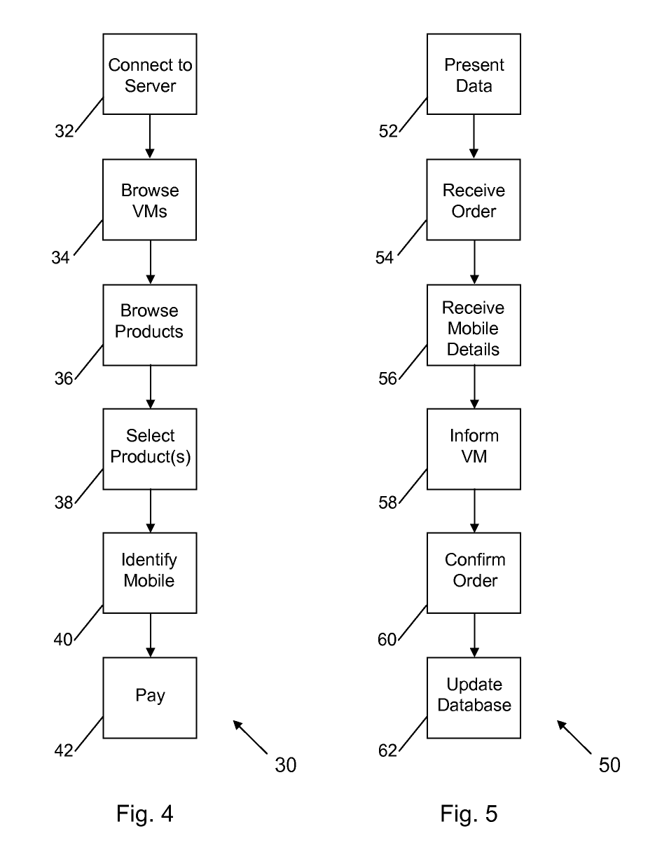

FIG. 4 is a flow chart showing an algorithm in accordance with an aspect of the present invention;

FIG. 5 is a flow chart showing an algorithm in accordance with an aspect of the present invention;

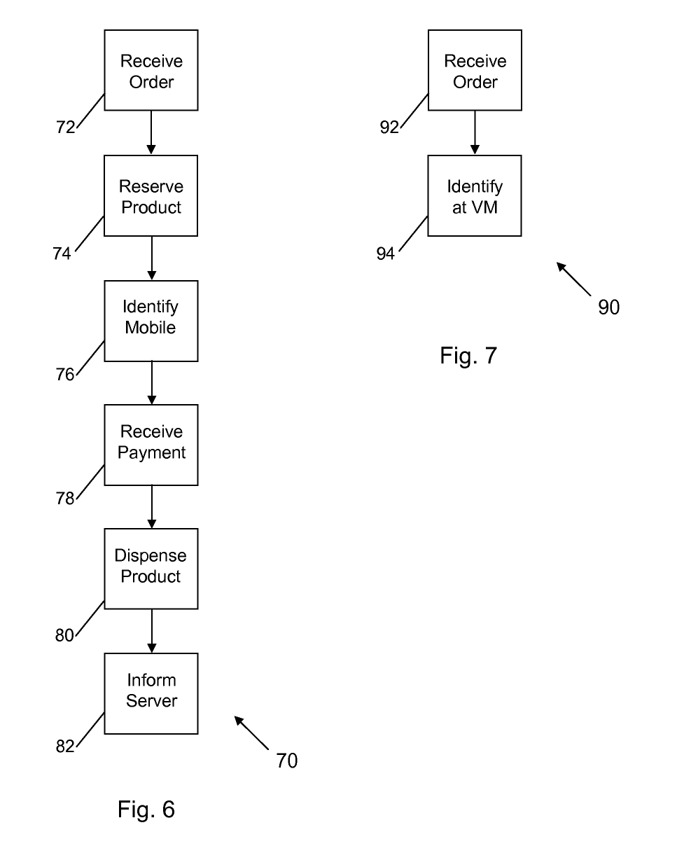

FIG. 6 is a flow chart showing an algorithm in accordance with an aspect of the present invention; and

FIG. 7 is a flow chart showing an algorithm in accordance with an aspect of the present invention.

FIG. 1 is a block diagram of a system, indicated generally by the reference numeral 1, in accordance with an aspect of the present invention.

The system 1 comprises a vending machine 2, an ordering device 4, a server 6 and a mobile communication device 8. The server 6 is in two-way communication with both the vending machine 2 and the ordering device 4. The ordering device 2 can be any device that is capable of enabling a user to interact with the server 6, where the server is typically a remote server. For example, the ordering device 4 might typically be a computing device (such as a laptop, a PC, tablet device etc.) or a mobile communication device (such as a mobile phone). Indeed, the ordering device may be the mobile communication device 8.

The mobile communication device 8 (which may or may not also be the ordering device 4) is in two-way communication with the server 6 and the vending machine 2, as described in detail below.

FIG. 2 is a flow chart, indicated generally by the reference numeral 10, showing an algorithm in accordance with an aspect of the present invention.

The algorithm 10 starts at step 12, where a user uses the ordering device 4 to select one or more products to purchase. Step 12 includes the ordering device 4 communicating with the server 6.

Next, at step 14, the user associates with mobile communication device 8 with the order. This step is required since, as discussed in detail below, the mobile communication device 8 is used to identify the order made at step 12 to the relevant vending machine 2. Of course, in embodiments in which the mobile communication device 8 is used as the ordering device, the step 14 is easily achieved. In embodiments in which different devices are used as the ordering device 4 and the mobile communication device 8, the step 14 may be achieved, for example, simply by providing the telephone number or some other identification detail of the mobile device 8 to the server 6.

Next, at step 16, the user identifies the mobile communication device in some way to the vending machine 2. As discussed in detail below, the step 16 could be implemented in many different ways, such as using near-field communication (NFC) systems to identify the mobile communication device 8 when it is presented at the vending machine 2.

At this stage, an order has been made by the ordering device 4, the order has been associated with the mobile communication device 8 and the mobile communication device has been identified at the vending machine 2. The final step of the algorithm, that of dispensing the selected product(s), can now be performed (step 18).

The algorithm 10 provides a mechanism to enable a user to order a product from a vending machine, without the user necessarily being located at the vending machine. Thus, the user could, for example, be sat at an office desk and place an order for an item at a nearby vending machine. The algorithm 10 enables the order to be associated with a mobile communication device (which may or may not be the same as the computing device used to place the order). Finally, the order is completed when the mobile communication device is identified at the vending machine in some way.

FIG. 3 is a block diagram of a system, indicated generally by the reference numeral 20, in accordance with an aspect of the present invention. The system 20 comprises the vending machine 2 and the mobile communication device 8 described above. As shown in FIG. 3, the vending machine 2 includes a near-field communications device 22. The mobile communication device 8 includes a corresponding near-field communication device 24. The near-field communications devices 22 and 24 enable the vending machine 2 to detect the presence of and to identify the mobile communication device 8.

Accordingly, the system 20 enables the vending machine 2 to carry out step 16 of the algorithm 10 (i.e. identify the presence of the mobile communication device 8). It should be stressed, however, that the use of near-field communications is only one exemplary method of implementing the step 16. Other examples include the use of Bluetooth communications or any other similar wireless communication system, such as cellular communication systems. Further examples include the use of a code. For example, step 14 of the algorithm 10 could include the server 6 sending a code to the mobile communication device 8, for example as an SMS message. Step 16 of the algorithm 10 could then be completed by the user simply entering the code at an interface of the vending machine 2. The skilled person will be aware of many alternative implementations of the step 16.

FIGS. 4 to 7 are flow charts in accordance with an exemplary implementation of the present invention. The flow chart of FIG. 4 (indicated by the reference numeral 30) shows the steps of the exemplary implementation as carried out by the ordering device 4. The flow chart of FIG. 5 (indicated by the reference numeral 50) shows the steps of the exemplary implementation as carried out by the server 6. The flow chart of FIG. 6 (indicated by the reference numeral 70) shows the steps of the exemplary implementation as carried out by the vending machine 2. Finally, the flow chart of FIG. 7 (indicated by the reference numeral 90) shows the exemplary implementation as carried out by the mobile communication device 8.

The algorithm 30 starts at step 32, where the ordering device 4 connects with the server 6. Next, at step 34, the ordering device 4 indicates which of a number of vending machines supported by the server 6 he wishes to use. The step 34 may, for example, present details of a number of vending machines that are geographically close to the user, or may present a number of vending machines that the user has used before. In some embodiments, the step 34 may be omitted, for example if the user has configured the system to indicate that he always wants to use the same vending machine.

Next, at step 36, the user browses the products available from the selected vending machine. The browsing process may allow the user to obtain a broad range of information concerning available products, such as price, ingredients, allergy advice etc. Also, the browser may enable the user to obtain information regarding the particular item available for sale, such as an expiry date.

The algorithm 10 then moves to step 38, where one or more products are selected by the user.

At this stage, the user has used the ordering device 4 to place an order for one or more products. The next step (step 40) is for the user to identify the mobile communication device 8 that will be presented at the vending machine 2 in order to complete the order. As discussed above, this step can be implemented in many different ways, such as by providing an identification number of the device 8 to the server 6. Of course, if the ordering device 4 and the mobile communication device 8 are the same device, then the step 40 is trivial.

Finally, at step 42, the user pays for the products. Payment may be made at the server (for example, using a card transaction, debiting a user account, or using mobile payment technology). Alternatively, payment may be made at the vending machine. Accordingly, the payment step 42 may not be required in the algorithm 30.

The steps 34, 36 and 38 need not be carried out in the order shown in FIG. 4. For example, after connecting to the server 6 (step 32), the user may browse (or otherwise indicate) the product(s) that he is interested in. Once the product has been selected (step 38), the user may decide which vending machine to use. The list of vending machine available for selection may, of course, be dependent on the product(s) selected in step 38.

As indicated above, FIG. 5 shows the steps of the exemplary implementation as carried out by the server 6.

The algorithm 50 shown in FIG. 5 starts at step 52, where the server 6 presents data to the ordering device 4. The data presented in step 52 may, for example, indicate the products that are available from a particular vending machine (enabling the browsing and selecting steps 36 and 38 to be carried out), may indicate the vending machines available to the user (enabling the step 34 to be carried out), or may provide both. The data provided in step 52 could be based on data stored in a database, or could be based on real-time information obtained from available vending machines. The user then uses the ordering device 4 to place an order at the server (step 54).

As described above with reference to step 40 of the algorithm 40, the ordering device 4 is used to identify the mobile communication device 8. This information is received at the server in step 56 of the algorithm 50.

Next, the server provides the relevant order information to the relevant vending machine 2 (step 58). The order information may include details of the product selected as well as details of the mobile communication device 8 that will be used to identify the order.

Once the order has been completed at the vending machine, a confirmation message is sent from the vending machine 2 to the server 6 (step 60). Finally, an inventory database is updated by the server (step 62). The inventory database may be used to provide users with data of products available in the step 52 described above. In embodiments in which real-time data from available vending machines is used, such an inventory may not be necessary and so step 62 may be omitted. Moreover, step 60 may be omitted in some embodiments.

The exemplary algorithm 50 enables an order to be placed by an ordering device 4 and completed by the vending machine 2. The algorithm 50 does not include means for the server collecting payment; however, this is possible, as will be readily apparent to the skilled person.

As indicated above, FIG. 6 shows the steps of the exemplary implementation as carried out by the vending machine 2.

The algorithm 70 shown in FIG. 6 starts at step 72, where the vending machine 2 receives order details sent from the server 6 in step 58 of the algorithm 50 described above.

Next, at step 74, the vending machine reserves the product for the user. In some embodiments, the product may be reserved for a limited period of time only. In other embodiments, the product may not be reserved at all and so the step 74 may be omitted.

The algorithm 70 now proceeds to step 76, where the mobile communication device 2 is identified at the vending machine 2. As discussed above, the step 76 may be implemented by the user presenting the mobile communication device 2 to a near-field communication (NFC) reader at the vending machine 2, although many other implementations are possible.

Next, at step 78, the vending machine receives payment for the product (although, of course, if payment has already been made, this step can be omitted).

The product is then dispensed by the vending machine (step 80). The server 6 may then be informed that the product has been dispensed (step 82), although this is not essential to all forms of the invention.

As indicated above, FIG. 7 shows the steps of the exemplary implementation as carried out by the mobile communication device 8.

The algorithm 90 shown in FIG. 7 starts at step 92, wherein the mobile communication device 8 receives details of the order made by the ordering device 4 at the server 6. The details of the order are typically sent from the server 6 to the mobile communication device 8. Of course, this step may be omitted if the mobile communication device 8 is also the ordering device 4. The step may indeed be omitted even if the ordering device 4 and the mobile communication device 8 are different devices, since the mobile communication device may only be required for identification and therefore does not necessarily need to know details of the order.

Next, at step 94, the mobile communication device is identified at the vending machine 2 (step 94). The ordered product can then be dispensed (see step 80 of the algorithm 70 described above).

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method, comprising:
placing an order for a vending machine product;
associating the order with a mobile communication device; and
using the mobile communication device to identify the order at the vending machine in order to complete the order.

2. A method as claimed in claim 1, wherein using the mobile communication device to identify the order comprises presenting the mobile communication device to a near-field communication interface at the vending machine.

3. A method as claimed in claim 1, wherein placing the order for a vending machine product is carried out using the said mobile communication device.

4. A method as claimed in claim 1, wherein payment for the order is made at a server remote from the vending machine.

5. A mobile communication device, comprising:
a first interface configured to communicate with a server to place an order for a vending machine product; and
a second interface configured to communicate with the vending machine to identify the order at the vending machine in order to complete the order.

6. A mobile communication device as claimed in claim 5, wherein the second interface is a near-field communication interface.

7. A method, comprising:
receiving data from a server regarding a product ordered by a user;
receiving identification data from the server identifying a mobile communication device of the user;
obtaining identification details of a presented mobile communication device;
determining whether the identification details of the presented mobile communication device match the identification data received from the server; and
if the presented mobile communication device matches the identification data received from the server, dispensing the ordered product.

8. A method as claimed in claim 7, wherein the obtaining identification details of the presented mobile communication device uses a near-field communication link.

9. A method as claimed in claim 7, further comprising reserving the ordered product for the user.

10. A method as claimed in claim 7, further comprising informing the server that the product has been dispensed.

11. A vending machine, comprising:
a first communication interface;
a second communication interface; and
a product dispenser, wherein
the first communication interface is configured to communicate with a server for receiving order information identifying a product ordered by a user and identifying a mobile communication device of the user, the second communication interface is configured to receive identification details of a mobile communication device presented at the vending machine, and wherein the product dispenser is configured to dispense the ordered product in the event that the mobile communication device presented at the vending machine matches the mobile communication device of the user.

12. A vending machine as claimed in claim 11, wherein the second communication interface comprises a near-field communication link.

13. A vending machine as claimed in claim 11, further comprising a processor for determining whether the mobile communication device presented at the vending machine matches the mobile communication device of the user.

14. A vending machine as claimed in claim 11, further comprising a third interface for informing the server that the product has been dispensed.

15. A method, comprising:
receiving an order for a vending machine product from a user;
associating the order with a mobile communication device of the user;
sending order information to the vending machine, wherein the order information includes details of the product and details of the mobile communication device.

16. A method as claimed in claim 15, further comprising receiving payment for the ordered product.

17. A method as claimed in claim 15, further comprising presenting information to the user regarding one or more available vending machines and/or one or more available products.

18. A server, comprising:
a first input for receiving an order for a vending machine product from a user;
a processor for associating the order with a mobile communication device of the user;
a first output for sending order information to the vending machine, wherein the order information includes details of the product and details of the mobile communication device.

19. A server as claimed in claim 18, further comprising a payment module configured to obtain payment for the ordered product from the user.

20. A server as claimed in claim 18, further comprising a second output for providing information to the user regarding one or more available vending machine and/or one or more available products.

21. A computer program product embodied on a computer-readable medium, said computer program including instructions which, when run on a processor, control said processor to perform:
placing an order for a vending machine product;
associating the order with a mobile communication device; and
using the mobile communication device to identify the order at the vending machine in order to complete the order.

22. A computer program product embodied on a computer-readable medium, said computer program including instructions which, when run on a processor, control said processor to perform:
receiving data from a server regarding a product ordered by a user;
receiving identification data from the server identifying a mobile communication device of the user;
obtaining identification details of a presented mobile communication device;
determining whether the identification details of the presented mobile communication device match the identification data received from the server; and
if the presented mobile communication device matches the identification data received from the server, dispensing the ordered product.

23. A computer program product embodied on a computer-readable medium, said computer program including instructions which, when run on a processor, control said processor to perform:
receiving an order for a vending machine product from a user;
associating the order with a mobile communication device of the user; and
sending order information to the vending machine, wherein the order information includes details of the product and details of the mobile communication device.
